(19) United States
(12) Patent Application Publication
(10) Pub. No.: US 2010/0032850 A1
(43) Pub. Date: Feb. 11, 2010

(54) De-Fouling Tubes for Cooling Tower

(76) Inventor: Sui-Ming Lin, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/185,861

(22) Filed: Aug. 5, 2008

(51) Int. Cl. B01F 3/04

(52) U.S. Cl. 261/36.1; 261/160; 261/151; 261/DIG. 11; 261/DIG. 46

(57) ABSTRACT

A tube in one embodiment is formed with a non-stick coating on its inner outer surface. Preferably, the non-stick coating is fluoropolymer. More preferably the fluoropolymer is PTFE. Another non-stick coating is formed on an inner surface of the tube in another embodiment. The non-stick coating served as a de-fouling layer is capable of preventing impurities in the water flowing through the tubes from precipitating thereonto. Hence, the performance of a cooling tower incorporating the tubes can be increased significantly.

### BACKGROUND OF THE INVENTION

1. Field of Invention

The invention relates to cooling towers and more particularly to a closed type cooling tower having a fluid cooler with a tube assembly including a plurality of series connected tubes having a cylindrical de-fouling layer of fluoropolymer coated thereon.

2. Description of Related Art

Many buildings are equipped with air cooling systems. A cooling tower is an important part of typical air cooling system. One type of cooling tower is cooling tower. The operation of a cooling tower (e.g., fluid cooler) involves passing working fluid (e.g., water) through a tube assembly, upon which clean water is sprayed by activating a motor driven circulating pump.

However, a fouling (e.g., magnesium oxide) layer may form on an outer surface of tubes of the tube assembly because impurities in the water precipitate thereonto. Fouling can reduce cross sectional area for heat to be transferred and cause an increase in the resistance to heat transfer across the tubes due to low thermal conductivity. Moreover, fouling can reduce the overall heat transfer efficiency of the fluid cooler. One solution of removing the fouling layers is periodic disassembly and cleaning of the tubes. Inevitably, it can lead to an increase in labor, pumping and maintenance costs. Thus, a need for improvement exists.

### SUMMARY OF THE INVENTION

It is therefore one object of the invention to provide a tube being formed with non-stick layer thereon so that the performance of a cooling tower incorporating the tubes can be increased significantly.

To achieve the above and other objects, the invention provides a fluid cooling mechanism for a cooling tower including a tower structure including a bottom collection basin, a lower air inlet above the collection basin for introducing dry air into the tower structure, and a top fan for drawing moist, warm air out of the tower structure; and a clean water circulating assembly including a circulating pump, a distribution pipe extending from the circulating pump into an upper portion of the tower structure, the distribution pipe having a spraying section below the fan, and a drain pipe in fluid communication between the circulating pump and the collection basin, the fluid cooling mechanism comprising an upper hot water inlet pipe for flowing a source of water to be cooled, a lower cold water outlet pipe, and a plurality of series connected tubes interconnecting the hot water inlet pipe and the cold water outlet pipe wherein each of the tubes has a non-stick first coating formed on an outer surface thereof.

In a first aspect of the invention the non-stick first coating is fluoropolymer.

In a second aspect of the invention the fluoropolymer is PTFE (polytetrafluoroethylene).

In a third aspect of the invention the tubes are disposed between the distribution pipe and the collection basin.

In a fourth aspect of the invention the spraying section has a plurality of orifices.

In a fifth aspect of the invention there is further provided a thermal conducting member in each of the tubes.

In a sixth aspect of the invention there is further provided a second non-stick coating on an inner surface of each of the tubes.

The above and other objects, features and advantages of the invention will become apparent from the following detailed description taken with the accompanying drawings.

### BRIEF DESCRIPTION OF THE DRAWINGS

FIG. 1 schematically depicts a cooling tower according to the invention;

FIG. 2 is a perspective view of a first preferred embodiment of de-fouling tube for cooling tower according to the invention;

FIG. 3 is a cross-sectional view of the tube of FIG. 2;

FIG. 4 is an exploded perspective view of the tube of FIG. 2;

FIG. 5 is a view similar to FIG. 1 showing a heat exchange operation of the cooling tower;

FIG. 6 is a perspective view of a second preferred embodiment of de-fouling tube for cooling tower according to the invention; and

FIG. 7 is a cross-sectional view of the tube of FIG. 6.

### DETAILED DESCRIPTION OF THE INVENTION

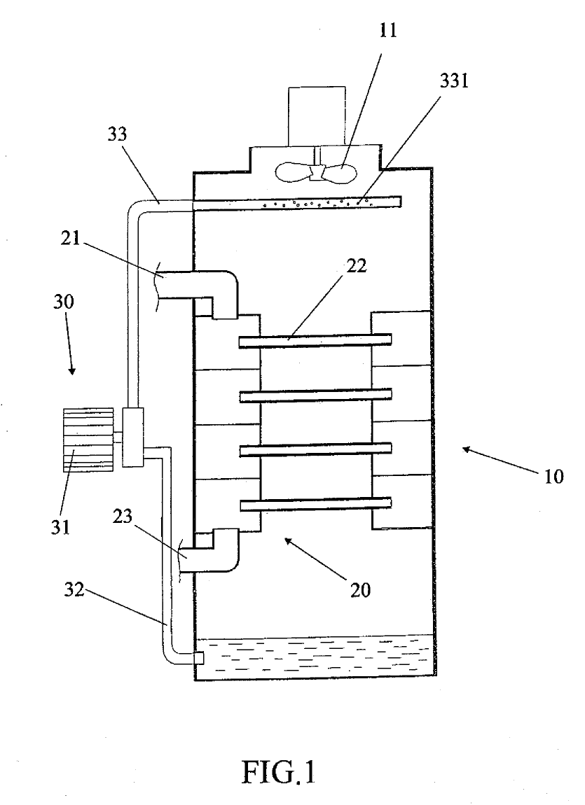

Referring to FIG. 1, a cooling tower in accordance with the invention is shown. The cooling tower comprises the following components as discussed in detail below.

A tower structure 10 comprises a collection basin 13 on the bottom, a lower air inlet 12 just above the collection basin 13 for introducing dry air into the tower structure 10, and a top fan 11 for inducing draft in order to draw moist, warm air out of the tower structure 10.

A clean water circulating assembly 30 comprises a motor driven circulating pump 311 a distribution pipe 33 extending from the circulating pump 31 into an upper portion of the tower structure 10, the distribution pipe 33 having a spraying section 331 with a plurality of orifices just below the fan 11, and a drain pipe 32 in fluid communication between the circulating pump 31 and the collection basin 13.

A fluid cooling loop 20 comprises an upper hot water inlet pipe 21 below the spraying section 331 for flowing a source of liquid (e.g., hot water) to be cooled, a lower cold water outlet pipe 23 above the collection basin 13, and a series of tubes 22 interconnecting the hot water inlet pipe 21 and the cold water outlet pipe 23. The tube 22 as the subject matter of the invention will be described in detail below.

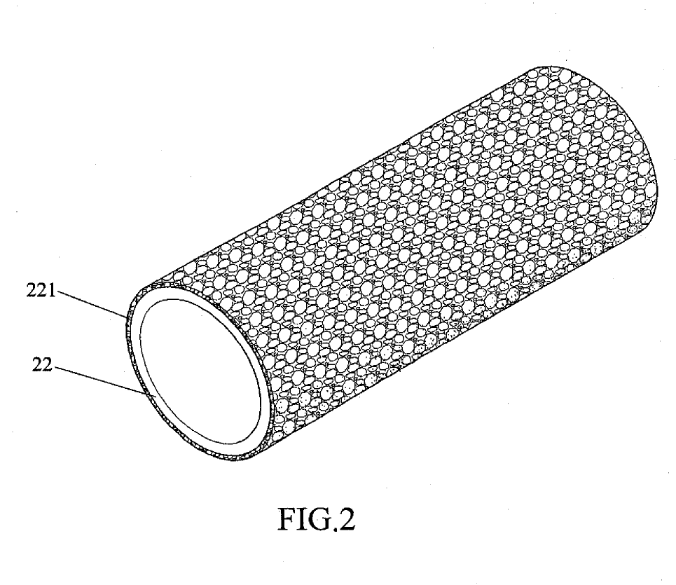

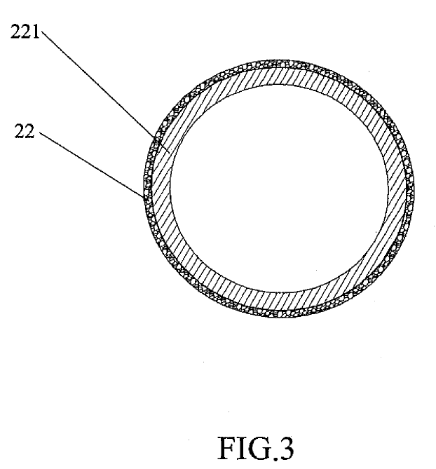

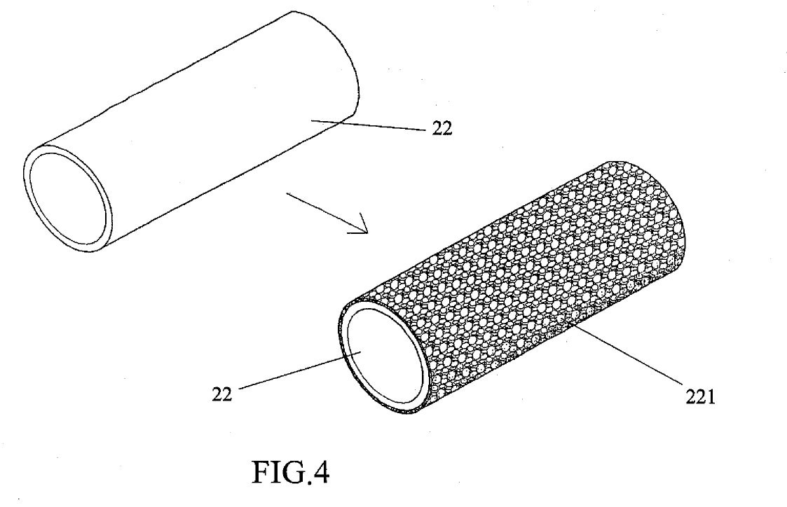

Referring to FIGS. 2 to 4, a first preferred embodiment of the tube 22 according to the invention is shown. The tube 22 comprises a non-stick coating 221 formed therearound. Preferably, the coating 221 is formed of fluoropolymer. More preferably, the coating 221 is formed of PTFE (polytetrafluoroethylene) (e.g., Teflon as being commercially known). Either fluoropolymer or PTFE is a material capable of prohibiting contaminants (e.g., reaction by-products, impurities, soluble and insoluble materials, etc.) in the water from adhering onto an outer surface of the tube 22. Hence, the undesirable fouling layer is prevented from forming on the outer surface of the tube 22. In brief, the tube 22 is a de-fouling tube.

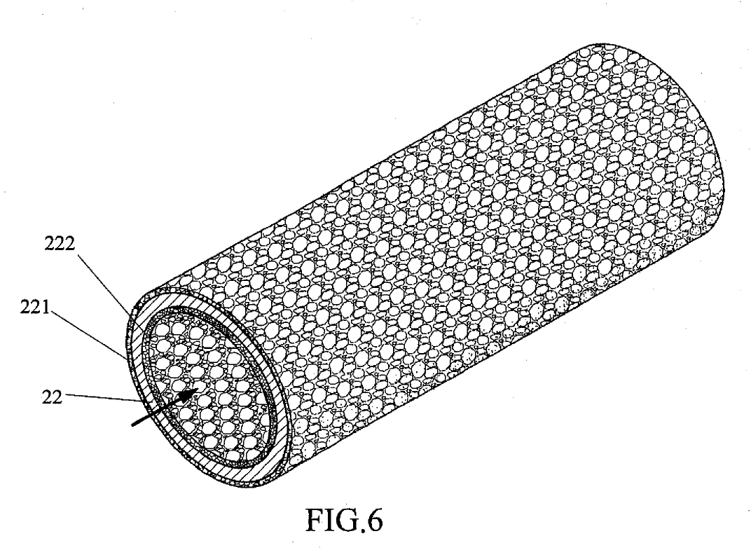

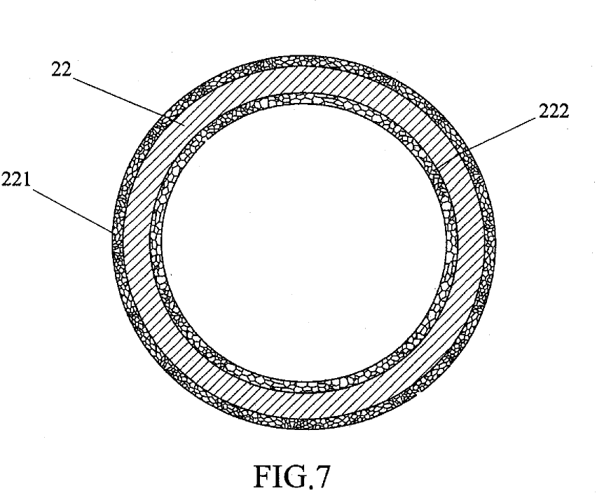

Referring to FIGS. 6 and 7, a second preferred embodiment of the tube 22 according to the invention is shown. In addition to forming a first non-stick coating 221 on the outer surface of the tube 22, a second non-stick coating 222 formed of either fluoropolymer or PTFE is formed on an inner surface of the tube 22. Hence, the undesirable fouling layer is also prevented from forming on the inner surface of the tube 22 as water flows through as indicated by arrow.

Preferably, the tube 22 is further formed with a member (not shown) of high thermal conductivity.

In brief, it is possible that the overall heat transfer coefficient and efficiency of the fluid cooling loop 20 and thus the performance of the cooling tower can be increased significantly by constructing the tubes 22 as above.

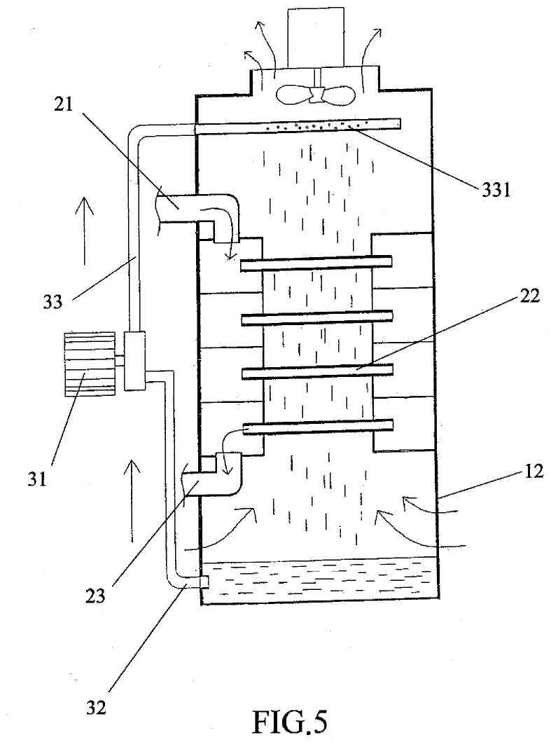

Referring to FIG. 5 in conjunction with FIG. 1, an operation of the cooling tower of the invention for cooling hot water flowing through the closed circuit type fluid cooling loop 20 will be described in detail below. First, the circulating pump 31 is activated to flow cold clean water to the distribution pipe 33. Water drops out of the orifices of the spraying section 331 into the internal space of the tower structure 10 to become water droplets. Heat of the hot water flowing through the tubes 22 is absorbed by water droplets hitting the tubes 22. Further, dry air is introduced into the tower structure 10 via the air inlet 12 by activating another fan (not shown). Hence, dry air absorbs heat from the water droplets to become moist, warm. Finally, the fan 11 draws the moist, warm air out of the tower structure 10.

Moreover, the cooled water droplets fall into the collection basin 13 to become cold water. The activating circulating pump 31 draws the cold water from the collection basin 13 to the distribution pipe 33 via the cold water outlet pipe 23.

In addition, hot water flowing through the tubes 22 becomes cold when arriving at the cold water outlet pipe 23. The cold water in the cold water outlet pipe 23 may flow to a hot source to absorb heat therefrom prior to flowing to the distribution pipe 33 again.

While the invention herein disclosed has been described by means of specific embodiments, numerous modifications and variations could be made thereto by those skilled in the art without departing from the scope and spirit of the invention set forth in the claims

What is claimed is:

1. A fluid cooling mechanism for a cooling tower including a tower structure including a bottom collection basin, a lower air inlet above the collection basin for introducing dry air into the tower structure, and a top fan for drawing moist, warm air out of the tower structure; and a clean water circulating assembly including a circulating pump, a distribution pipe extending from the circulating pump into an upper portion of the tower structure, the distribution pipe having a spraying section below the fan, and a drain pipe in fluid communication between the circulating pump and the collection basin, the fluid cooling mechanism comprising:
an upper hot water inlet pipe for flowing a source of water to be cooled, a lower cold water outlet pipe, and a plurality of series connected tubes interconnecting the hot water inlet pipe and the cold water outlet pipe wherein each of the tubes has a non-stick first coating formed on an outer surface thereof.

2. The fluid cooling mechanism of claim 1, wherein the non-stick first coating is PTFE (polytetrafluoroethylene).

3. The fluid cooling mechanism of claim 1, wherein the non-stick first coating is fluoropolymer.

4. The fluid cooling mechanism of claim 3, wherein the fluoropolymer is PTFE.

5. The fluid cooling mechanism of claim 1, wherein the tubes are disposed between the distribution pipe and the collection basin.

6. The fluid cooling mechanism of claim 1, wherein the spraying section has a plurality of orifices.

7. The fluid cooling mechanism of claim 1, further comprising a thermal conducting member formed in each of the tubes.

8. The fluid cooling mechanism of claim 1, further comprising a second non-stick coating formed on an inner surface of each of the tubes.

9. The fluid cooling mechanism of claim 8, wherein the non-stick second coating is PTFE.

10. The fluid cooling mechanism of claim 8, wherein the non-stick second coating is fluoropolymer.

11. The fluid cooling mechanism of claim 10, wherein the fluoropolymer is PTFE.
